(19) United States
(12) Patent Application Publication
(10) Pub. No.: US 2024/0407392 A1
(43) Pub. Date: Dec. 12, 2024

(54) PROCESS FOR IMPROVING FLAVOR OF MEAT ANALOGS

(71) Applicant: GIVAUDAN SA, VERNIER (CH)

(72) Inventors: Laura STIDHAM, Cincinnati, OH (US); Katherine BROWNRIDGE, Cincinnati, OH (US); Yuangang ZHANG, Cincinnati, OH (US)

(21) Appl. No.: 18/699,822

(22) PCT Filed: Oct. 3, 2022
(86) PCT No.: PCT/EP2022/077479

§ 371 Date: Apr. 9, 2024

Related U.S. Application Data
(60) Provisional application No. 63/256,857, filed on Oct. 18, 2021.

(51) Int. Cl. A23J 3/22; A23J 3/14; A23J 3/26; A23L 27/26

(52) U.S. Cl. CPC A23J 3/227; A23J 3/14; A23J 3/26; A23L 27/26

(57) ABSTRACT

A process of preparing a meat analog having an improved upfront and long-lasting flavor, the process comprising the steps of: a) adding at least one first flavorant to a hydration step of non-animal derived protein, and b) adding at least one second flavorant to a further ingredient addition step, wherein steps a) and b) can be performed in any order.

### TECHNICAL FIELD

The present disclosure relates to a process for providing an authentic upfront and long-lasting flavor to meat analog products.

### BACKGROUND

The flavor industry is continuously striving to enhance, improve or modify the flavor character of consumables. Many consumables contain added flavorants to provide the product with a desired taste, and to enhance the products' overall flavor perception in the mouth. Meat analogs prepared according to known processes typically provide an unbalanced flavor and impact. In particular, such meat analog products either i) impart poor upfront flavor or impact, or ii) impart a high upfront flavor but lack flavor impact after chewing a couple of times. Accordingly, there remains a need for a process for preparing meat analogs having a balanced and authentic flavor profile.

### SUMMARY

Disclosed is a process of preparing a meat analog having an improved upfront and long-lasting flavor, the process comprising the steps of: a) adding at least one first flavorant to a hydration step of non-animal derived protein, and b) adding at least one second flavorant to a further ingredient addition step, wherein steps a) and b) can be performed in any order.

Additionally disclosed is a meat analog obtained by a process comprising the steps of: a) adding at least one first flavorant to a hydration step of non-animal derived protein, and b) adding at least one second flavorant to a further ingredient addition step, wherein steps a) and b) can be performed in any order.

Further disclosed is a process of providing an authentic meaty flavor with both upfront and long-lasting flavor to a meat analog, the process comprising the steps of: a) adding at least one first flavorant to a hydration step of non-animal derived protein, and b) adding at least one second flavorant to a further ingredient addition step, wherein steps a) and b) can be performed in any order.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The present disclosure is based on the surprising discovery that an improved overall flavor and sensory experience can be achieved in meat analog products using the disclosed processes. Typically, flavors are added in one phase of the production of meat analogs. It has been found that a meat analog prepared by adding at least one first flavorant in a protein hydration step and at least one second flavorant in a further ingredient addition step provides an authentic meaty flavor with both upfront and long-lasting flavor impact. The process also provides for the preparation of a meat analog having an authentic meaty character and enhanced juiciness, body and mouthfeel.

The flavor of consumables consists of two parts: the aroma and the taste. In general, what is perceived through the olfactory epithelium in the nasal cavity is referred to as ‘aroma’, whereas the term ‘taste’ is generally used to describe the sensory impact that is perceived via the mouth, especially the tongue. The flavor sensation experienced upon consumption, especially taste, provides the final analysis of food prior to ingestion thereof. In certain non-limiting embodiments, the sensory experience of a person exposed to a flavor can be classified as a characteristic experience for the particular flavor. For example, a flavor can be identified by a person as being, but not limited to, a smoky, cheesy, meaty, etc., flavor.

As used herein, the term “taste” is used to describe the sensory response related to taste receptors. The quality of taste may be expressed as the interplay of descriptors. For example, “meaty”, associated with a savoury perception: “body”, associated with combination of perception of heaviness on the tongue, thickness, creaminess and/or fattiness; and “longevity”, associated with time that a full integrated sensory experience sustains itself in the mouth after swallowing. This list of descriptors is not limiting and descriptors may change depending on the application.

The term “impact” as used herein is used to describe the overall intensity of the sensory response of the “taste” defined herein above.

A meat analog is a food product that approximates the aesthetic properties (for example, appearance, flavor, and texture), chemical characteristics and cooking properties of certain types of meat. Meat analogs are also referred to in the food industry as animal protein analogs, meat alternatives, meat substitutes, mock meat, faux meat, imitation meat, vegetarian meat or vegan meat. Meat analogs are increasingly desired by health-conscious non-vegetarians, vegetarians, vegans, persons following religious dietary restrictions, persons seeking reduction of fat in their diet, persons seeking to reduce or eliminate consumption of processed real meat, others seeking to reduce consumption of meat for other ethical or nutritional reasons, and to achieve the reduction of fat while maintaining the same fat perception.

Disclosed is a process of preparing a meat analog having an improved upfront and long-lasting meaty flavor, the process comprising the steps of: a) adding at least one first flavorant to a hydration step of non-animal derived protein, and b) adding at least one second flavorant to a further ingredient addition step, wherein steps a) and b) can be performed in any order.

In certain embodiments, the at least one first flavorant in the hydration step is the same or different than the at least one second flavorant in the further ingredient addition step. In certain embodiments, the at least one first flavorant in the hydration step is the same as the at least one second flavorant in the further ingredient addition step. In certain embodiments, the at least one first flavorant in the hydration step is different than the at least one second flavorant in the further ingredient addition step.

In certain embodiments, the at least one first flavorant in the hydration step and/or the at least one second flavorant in the further ingredient addition step is selected from the group consisting of: a chicken flavor, a beef flavor, a wagyu flavor, a pork flavor, a veal flavor, a duck flavor, a goose flavor, a lamb flavor, a turkey flavor, a fish flavor, a seafood flavor, and mixtures thereof. Suitable flavor are commercially available from Givaudan Flavors Corp. (Cincinnati, Ohio).

By “flavorant” it is meant a composition created by a flavorist using methods known to the skilled person that may be a mixture of tastants, aroma compounds and/or sensates. The flavorant may be a liquid, gel, colloid, or particulate solid, for example, an oil, an extract, an oleoresin, or the like. In certain embodiments, flavorants may include any one or more food-grade flavorants that do not substantially dissolve in water. In certain embodiments, at least one non-aqueous flavorant is added to the hydration step and/or the further ingredient addition step. Examples of flavorants, in particular aromatic or volatile flavorants are for instance essential oils, and other volatile flavorants, like savoury flavorants.

The hydration step and the further ingredient addition step may include a sufficient amount of at least one flavorant to impart a desired level of flavor or taste. A single flavorant or combinations of two or more flavorants may be included in the hydration step and/or the further ingredient addition step to prepare a variety of meat analog products having different flavors or tastes. Without limitation, and only by way of illustration, the flavorants may include beef flavor, pork flavor, veal flavor, chicken flavor, duck flavor, goose flavor, lamb flavor, turkey flavor, fish flavor, seafood flavors (including, for example, lobster, clam, crab, mussel, scallop, shrimp, oyster) fruity flavors, seasonings, spices, herbs, sweet tastants, salty tastants, umami tastants, taste enhancers, taste modifiers, and the like. According to certain embodiments, a beef and/or chicken flavorant may be added to the hydration step and/or the further ingredient addition step. There may also be one or more acids present in the at least one flavorant to induce succulence and saliva production.

Examples of suitable flavorants include natural flavors, artificial flavors, spices, seasonings, and the like. Exemplary flavorants include synthetic flavor oils and flavoring aromatics and/or oils, oleoresins, essences, and distillates, and a combination comprising at least one of the foregoing. Generally, any flavorant such as those described in “Chemicals Used in Food Processing”, Publication No 1274, pages 63-258, by the National Academy of Sciences, can be used.

In certain embodiments, the at least one first flavorant is added to the hydration step in an amount of about 0.1% to about 20% by weight, or about 0.5% to about 10% by weight, or about 1% to about 5% by weight, or about 1% to about 3% by weight, based on the total weight percent of the hydration step ingredients.

In certain embodiments, the at least one second flavorant is added to the further ingredient addition step in an amount of about 10% to about 90% by weight, or about 20% to about 80% by weight, or about 30% to about 70% by weight, or about 40% to about 60% by weight, based on the total weight percent of the further ingredient addition step ingredients.

In certain embodiments, the at least one first flavorant in the hydration step and the at least one second flavorant in the further ingredient addition step are added in substantially the same amount based on the total weight of the meat analog. According to this embodiment, the at least one first flavorant in the hydration step and the at least one second flavorant in the further ingredient addition step are both present in an amount of about 0.5% by weight about, or 1% by weight, or about 2% by weight, or about 3% by weight, based on the total weight percent of the meat analog.

All meat analog weight percentages provided herein are based on uncooked meat analog products.

In certain embodiments, the further ingredient addition step contains substantially no water. The term “substantially no” as used in reference to water content in the further ingredient addition step means that water constitutes less than about 10% by weight, or less than about 5% by weight, or less than about 2% by weight, or less than about 1% by weight, or less than about 0.5% by weight, or less than about 0.1% by weight, or 0% by weight, based on the total weight percent of the further ingredient addition step ingredients.

In certain embodiments, water is added in the hydration step in an amount of at least 30% by weight, or at least 40% by weight, or at least 50% by weight, or at least 55% by weight, based on the total weight percent of the hydration step ingredients. In certain embodiments, water is added in the hydration step in an amount of about 30% to about 70% by weight, or about 40% to about 60% by weight, or about 45% to about 55% by weight, based on the total weight percent of the hydration step ingredients.

In certain embodiments, non-animal derived protein is placed in a vacuum sealable bag containing water and vacuum sealed for about 15 seconds and then allowed to rest until the non-animal derived is partially or completely hydrated. The non-animal derived protein is hydrated during the hydration step for a period of time ranging from about 10 to about 30 minutes, or about 15 to about 25 minutes, or about 15 to about 20 minutes.

In certain embodiments, the non-animal derived protein is added in the hydration step in an amount of at least 20% by weight, or at least 30% by weight, or at least 40% by weight, based on the total weight percent of the hydration step ingredients. In certain embodiments, the non-animal derived protein is added in the hydration step in an amount of about 20% to about 60% by weight, or about 30% to about 50% by weight, or about 35% to about 45% by weight, based on the total weight of the hydration step ingredients.

In certain embodiments, the ingredients added in the hydration step include water, at least one non-animal derived protein, at least one first flavorant, and optionally a plant-protein off-taste masking agent, and further optionally an edible salt. Edible salts include those typically employed in the food and beverage industry and include chlorides, sulphates, phosphates, gluconates, sodium, citrates, carbonates, acetates and lactates. In certain embodiments, the ingredients added in the hydration step include water, at least two different non-animal derived proteins, at least one first flavorant, optionally a plant-protein off-taste masking agent, and further optionally an edible salt. In certain embodiments, the ingredients added in the hydration step include water, at least one non-animal derived protein, at least one cell-based meat, at least one first flavorant, optionally a plant-protein off-taste masking agent, and further optionally an edible salt.

In certain embodiments, the ingredients added in the further ingredient addition step include at least one second flavorant, a plant-protein off-taste masking agent, and an edible salt. Edible salts include those typically employed in the food and beverage industry and include chlorides, sulphates, phosphates, gluconates, sodium, citrates, carbonates, acetates and lactates.

In certain embodiments, the non-animal derived protein comprises at least one of: beans, broccoli, edamame, mycoprotein, nuts, oatmeal, peas, soy, potatoes, chickpea, seeds, plant leaf proteins, cereal, seitan, tempeh or tofu. According to certain illustrative embodiments, the beans comprise at least one of: black beans, faba beans, canelli beans, kidney beans, lentil beans, lima beans, pinto beans, soy beans, white beans, or mung beans: wherein the nuts comprise at least one of: almonds, brazil nuts, cashews, peanuts, pecans, hazelnuts, pine nuts, or walnuts; wherein the peas comprise at least one of: black eyed peas, chickpeas, or green peas: wherein the seeds comprise at least one of: chia, flax, hemp, pumpkin, sesame, or sunflower; and wherein the cereal comprises at least one of: oat, wheat, barley, spelt, corn, or rice.

In certain embodiments. “non-animal derived protein” refers to protein preparations made from raw materials including, but not limited to, grain (rice, millet, maize, barley, wheat, oat, sorghum, rye, teff, triticale, amaranth, buckwheat, quinoa): legume or pulses, beans (such as soy bean, mung beans, faba beans, lima beans, runner beans, kidney beans, navy beans, pinto beans, azuki beans, and the like), peas (such as green peas, yellow peas, chickpeas, pigeon peas, cowpea, and black-eyed peas and the like), sesame, garbanzo, potatoes, lentils, and lupins: seed and oilseed (black mustard. India mustard, rapeseed, canola, safflower, sunflower seed, flax seed, hemp seed, poppy seed, pumpkin, chia, sesame): nuts (almond, walnut. Brazil. Macadamia, cashews, chestnuts, hazelnuts, pine, pecans, peanuts, pistachio and gingko): algal (kelp, wakame, spirulina, chlorella): mycoprotein and/or fungal protein.

Exemplary non-animal derived proteins include soy protein and pea protein. As used herein, soy includes all consumables containing soy in any form, including soybean oil used either alone, in combination, for example as a nutraceutical, or as a medicament, soybean curd, soy milk, soy butter or soy paste. Without limitation, suitable soy protein isolates are commercially available from Danisco A/S (Copenhagen. Denmark) under the designations SUPRORMAX 5010, SUPRORMAX 5050, SUPRORMAX 6510, and SUPRORMAX 6550. Without limitation, a suitable textured pea protein is commercially available from Roquette Freres SA (Lestrem, France) under the designation NUTRALYSR T70S. In certain embodiments, the non-animal protein is selected from at least one of: grain, legume, pulses, seed, oilseed, nut, algal, mycoprotein, fungal protein, insects or leaf protein.

In certain embodiments, the non-animal derived protein is present in an amount of at least 10% by weight, or at least 20% by weight, or at least 30% by weight, or at least 40% by weight, or at least 50% by weight, based on the total weight percent of the meat analog. In certain embodiments, the non-animal derived protein is present in an amount of about 10% to about 50% by weight, based on the total weight of the meat analog. In certain embodiments, the non-animal derived protein is present in an amount of about 20% to about 35% by weight, based on the total weight of the meat analog.

The disclosed process may be used to prepare a wide variety of meat analog products, including hybrid meat comprising a plant-originated substance with cultured animal cells or meat substitute products. According to certain embodiments, the meat analog is a vegetarian food product. In other embodiments, the meat analog is a vegan food product containing only plant-derived components and no animal-derived components. According to certain embodiments, the disclosed process may be used to prepare a wide variety of consumable or otherwise edible non-animal-based meat analog, meat replica, cultivated meat, cultured meat, clean meat, in vitro meat, synthetic meat, cell-based meat, hybrid meat comprising a plant-originated substance with cultured animal cells or meat substitute products. The disclosed processes can be used in additive manufacturing or 3D printing processes. Suitable non-animal based consumable products can be formulated, for example, without limitation, as hot dogs, burgers, ground meat, sausage links, sausage patties, kebabs, canned products, steaks, filets, roasts, breasts, thighs, wings, meatballs, meatloaf, bacon, strips, fingers, nuggets, cutlets, and cubes. “Meat analog” is a food product that approximates the aesthetic qualities and/or chemical characteristics of certain types of meat. The term meat analog includes those prepared with textured vegetable proteins (TVP), high moisture meat analog (HMMA) and/or low moisture meat analog (LMMA) products.

Food scientists have devoted much time developing methods for preparing acceptable meat-like food applications, such as beef, chicken, pork, poultry, fish, and shellfish analogs, from a wide variety of non-animal proteins. One such approach is texturization into fibrous meat analogs, for example, through extrusion processing. The resulting meat analog products exhibit improved meat-like visual appearance and improved texture.

Meat analog products are produced with high moisture content and provide a product that simulates the fibrous structure of animal meat and has a desirable meat-like moisture, texture, mouthfeel, flavor and color.

Texturization of protein is the development of a texture or a structure via a process involving heat, and/or shear and the addition of water. The texture or structure will be formed by protein fibers that will provide a meat-like appearance and perception when consumed. The mechanism of texturization of proteins starts with the hydration and unfolding of a given protein by breaking intramolecular binding forces by heat and/or shear. The unfolded protein molecules are aligned and bound by shear, forming the characteristic fibers of a meat-like product. In one embodiment, polar side chains from amino acids form bonds with linear protein molecules and the bonds will align protein molecules, forming the characteristic fibers of a meat-like product.

To make non-animal proteins palatable, texturization into fibrous meat analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the non-animal protein, typically introduced to the extruder in the form of a dry blend, is processed to form a fibrous material.

More recent developments in extrusion technology have focused on using twin screw extruders under high moisture (40-80%) conditions for texturizing non-animal proteins into fibrous meat alternatives. In the high moisture twin screw process, also known as “wet extrusion”, the raw materials, predominantly non-animal proteins such as soy and/or pea protein, are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's long slit cooling die contribute to the formation of a fibrous structure. The resulting wet-extruded products tend to exhibit improved whole muscle meat-like visual appearance and improved palatability. Therefore, this extrusion technology shows promise for texturizing non-animal proteins to meet increasing consumer demands for healthy and tasty foods.

Texturization processes may also include spinning, simple shear flow, and simple shear flow and heat in a Couette Cell (“Couette Cell” technology). The spinning process consists of unfolding protein molecules in a high alkaline pH solution, and coagulating the unfolded protein molecules by spraying the protein alkaline solution into an acid bath. The spraying is made by a plate with numerous fine orifices. The protein coagulates forming fibers as soon as it gets in contact with the acid medium. The fibers are then washed to remove remaining acid and/or salts formed in the process. A Couette Cell is a cylinder-based device where the inner cylinder rotates and the outer cylinder is stationary, being easy to scale up. The Couette Cell operates under the same principle of forming protein fibers by subjecting the protein to heat and shear in the space between the stationary cylinder and the rotational cylinder.

With respect to simple shear flow and heat in a Couette Cell, this process can induce fibrous structural patterns to a granular mixture of non-animal proteins at mild process conditions. This process is described in “On the use of the Couette Cell technology for large scale production of textured soy-based meat replacers”. Journal of Food Engineering 169 (2016) 205-213, which is incorporated herein by reference.

Meat analog products having qualities (for example, texture, moisture, mouthfeel, flavor, and color) similar to that of whole muscle animal meat may be produced using non-animal proteins formed using extrusion under conditions of relatively high moisture. In one embodiment, meat analog products may include non-animal protein, one or more of flour, starch, and edible fiber, an edible lipid material.

In certain compositions, the amount of non-animal protein included in the mixture to be extruded includes no more than about 90% by weight of the dry ingredients. For example, the amount of non-animal protein present in the ingredients utilized to make meat analog products according to the present disclosure may range from about 3% to about 90% by weight of the dry ingredients. In another embodiment, the amount of non-animal protein present in the ingredients utilized to make meat analog products according to the present disclosure may range from about 10% to about 80% by weight of the dry ingredients. In a further embodiment, the amount of non-animal protein present in the dry ingredients utilized to make meat analog products according to the present disclosure may range from about 25% to about 50% by weight. In another further embodiment, the amount of non-animal protein present in the dry ingredients utilized to make meat analog products according to the present disclosure may be about 40%.

The term “dry ingredients” includes all the ingredients in the mixture to be extruded except for added water and ingredients added with the added water (i.e., the “wet ingredients”).

In addition to the foregoing, the meat analog product includes water at a relatively high amount. In one embodiment, the total moisture level of the mixture extruded to make the meat analog product is controlled such that the meat analog product has a moisture content that is at least about 50% by weight. To achieve such a high moisture content, water is typically added to the ingredients. Although, a relatively high moisture content is desirable, it may not be desirable for the meat analog product to have a moisture content much greater than about 65%. As such, in one embodiment the amount of water added to the ingredients and the extrusion process parameters are controlled such that the meat analog product (following extrusion) has a moisture content that is from about 40% to about 65% by weight.

Among the suitable extrusion apparatuses useful in the practice of the described process is a commercially available double barrel, twin-screw extruder apparatus such as a Wenger TX 52 model manufactured by Wenger (Sabetha, Kansas) or Clextral BC21 model manufactured by Clextral (France).

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus: however, it is typically from about 100 to about 750 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding non-animal protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C., to about 70° C. In one embodiment, the dry premix is transferred through multiple heating zones within the extrusion apparatus, with the protein mixture heated to a temperature of from about 25° C., to about 160° C., such that the molten extrusion mass enters the extrusion die at a temperature of from about 160° C. In one embodiment, the protein mixture is heated in the respective heating zones to temperatures of about 65° C., about 95° C., about 150° C., and about 160° C.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw speed, feed rate of the mixture to the barrel, feed rate of water to the barrel, and the viscosity of the molten mass within the barrel.

Water along with additional “wet ingredients” is injected into the extruder barrel to hydrate the non-animal protein mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above.

Textured vegetable proteins (TVPs) can be defined as food products made from edible protein sources and characterized by having structural integrity and identifiable texture such that each unit will withstand hydration in cooking and other procedures used in preparing the food for consumption. A majority of TVPs produced today are produced by extrusion technology. These TVPs are often rehydrated with 60-65% moisture and blended with other ingredients including, but not limited to, binders, meats, other TVPs, flavors, excipients, fats, oils, or seasonings.

The low-moisture meat analog (LMMA) product is most often cut with an extruder knife at the extruder die to form the finished product size and shape. Drying after extrusion, to remove moisture, improves storage, handling, and shelf-stability. These LMMAs are often rehydrated with 60-70% moisture. Additionally, other food ingredient items can be added to improve finished product functionality and appearance, including, but not limited to, oil, other proteins, salt, seasonings, flavors, maskers, enhancers, or binders. Generally re-hydrated LMMA contains 40-80% moisture, 0)-25% oil, 5-30% protein.

A typical formulation of LMMA contains water, protein concentrates, protein isolates, oil, a binder (e.g, cellulose, vital wheat gluten) and flavors, maskers, seasonings, etc, that provide a taste and texture closer to an animal meat product.

According to certain embodiments, the process further includes an emulsion step. The emulsion step may include preparing an aqueous emulsion by mixing a non-animal fat component with an emulsifying agent.

In certain embodiments, the non-animal fat comprises solid fats, semi-solid fats, oils and combinations thereof. According to certain embodiments, the oils that may constitute the fat component of the composition comprise algal oils, insect oils, vegetable-derived oils and combinations thereof. The non-animal fat may include medium chain glycerides (MCT), saturated fatty acids, unsaturated fatty acids (mix of both). According to certain embodiments, the fat component comprises one or more vegetable-derived oils. Without limitation, and only by way of illustration, suitable vegetable oils include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof. Without limitation, a suitable non-animal fat is pure canola oil that is commercially available from The Kroger Company (Cincinnati, Ohio).

In certain embodiments, at least one non-animal fat is added to the emulsion step in an amount of at least 1% by weight, or at least 5% by weight, or at least 10% by weight, based on the total weight percent of the emulsion step ingredients. In certain embodiments, at least one non-animal fat is added to the emulsion step in an amount of about 1% to about 25% by weight, or about 10% to about 15% by weight, based on the total weight of the emulsion step ingredients.

In certain embodiments, a suitable amount of at least one emulsifier for the fat is added to the emulsion step to emulsify the fat and to create a fat/oil-in-water emulsion. For purposes of this disclosure, an emulsifier is any substance that includes a hydrophilic (ie, at least partially water soluble) portion and a hydrophobic (ie, lipophilic) portion, and is capable of lowering or otherwise reducing the surface tension between the normally immiscible fat and water to create a fat/oil-in-water emulsion or to create a water-in-fat/oil emulsion. Any emulsifier that is generally regarded as safe for inclusion in an edible food product that is intended for human or pet consumption, and that is capable of emulsifying the fat to create the emulsion, may be used as an emulsifier in the disclosed process.

The emulsifiers may be anionic emulsifiers, cationic emulsifiers, non-ionic emulsifiers and amphoteric emulsifiers. According to certain embodiments, and without limitation, the emulsifiers having an HLB value of 1 to 18 may be used in the disclosed process. Without limitation, and only by way of illustration, suitable fat emulsifiers include celluloses, monoglycerides, diglycerides, acylated monoglycerides, lactylated monoglycerides succinylated monoglycerides, alkoxylated monoglycerides (such as ethoxylated monoglycerides), alkoxylated diglycerides (such as ethoxylated diglycerides), esters of monoglycerides (such as diacetyl tartaric acid esters of monoglycerides), lethicins (such as soy lecithin and lecithin from egg yolk), succinic acid modified starches, gum Arabic, succinic acid modified gum Arabic. Quillaya saponins, magnesium stearate, calcium, potassium and sodium salts of fatty acids, polysorbates, alkali metal stearoyl lactylate (such as sodium stearoyl lactylate), sugar esters, alkaline earth metal stearoyl lactylate (such as calcium stearoyl lactylate), sodium phosphates, proteins, and mixtures thereof. According to certain illustrative embodiments, the emulsifier may comprise methylcellulose.

In certain embodiments, at least one emulsifier is added to the emulsion step in an amount of at least 0.1% by weight, or at least 1% by weight, or at least 5% by weight, based on the total weight percent of the emulsion step ingredients. In certain embodiments, at least one emulsifier is added to the emulsion step in an amount of about 0.1% to about 20% by weight, or about 1% to about 15% by weight, or about 2% to about 10% by weight, based on the total weight of the emulsion step ingredients.

In certain embodiments, water is added in the emulsion step in an amount of at least 30% by weight, or at least 40% by weight, or at least 50% by weight, or at least 60% by weight, or at least 70% by weight based on the total weight percent of the emulsion step ingredients. In certain embodiments, water is added in the hydration step in an amount of about 40% to about 90% by weight, or about 50% to about 80% by weight, or about 60% to about 75% by weight, based on the total weight percent of the emulsion step ingredients.

In certain embodiments, a non-animal derived protein is added to the emulsion step. According to this embodiment, the non-animal derived protein added to the emulsion step may be the same or different than the non-animal derived protein added to the hydration step. In certain embodiments, the non-animal derived protein added to the emulsion step is the same as the non-animal derived protein added to the hydration step. In certain embodiments, the non-animal derived protein added to the emulsion step is different than the non-animal derived protein added to the hydration step.

In certain embodiments, at least one non-animal derived protein is added in the emulsion step in an amount of at least 1% by weight, or at least 5% by weight, or at least 10% by weight, based on the total weight percent of the emulsion step ingredients. In certain embodiments, at least one non-animal derived protein is added in the emulsion step in an amount of about 1% to about 50% by weight, or about 1% to about 40% by weight, or about 1% to about 30% by weight, or about 5% to about 20% by weight, or about 5% to about 15% by weight, based on the total weight percent of the emulsion step ingredients.

In certain embodiments, the hydration step and the further ingredient addition step are performed separately. In certain embodiments, the hydration step, the further ingredient addition step, and the emulsion step are performed separately. In certain embodiments, the hydration step is performed by adding and weighing water, at least one non-animal derived protein, at least one first flavorant, and a plant-protein off-taste masking agent in a vacuum sealable bag. Vacuum sealing the bag for approximately 15 seconds and then allowing to rest for 15-20 minutes until the non-animal derived protein is at least partially hydrated. In certain embodiments, the further ingredient addition step is performed by adding, mixing and weighing at least one second flavorant, an edible salt and a plant-protein off-taste masking agent in a container. In certain embodiments, the emulsion step is performed by adding and weighing water, at least one non-animal derived fat, at least one non-animal derived protein, and at least one emulsifying agent in mini food processor. The hydration step ingredients, the further ingredient addition step ingredients, and the emulsion step ingredients can then be added to a mixer for about 1 to about 15 minutes. The resulting uncooked meat analog product can then be processed for reasons of palatability, efficiency, cost and the like. For example, the uncooked meat analog product can be rolled out, subjected to a blast freeze treatment, cut into desired shapes or pieces, battered, and breaded.

Additionally disclosed is a meat analog product obtained by a process comprising the steps of: a) adding at least one first flavorant to a hydration step of non-animal derived protein, and b) adding at least one second flavorant to a further ingredient addition step, wherein steps a) and b) can be performed in any order.

The meat analog obtained by the process described herein may include hybrid meat comprising a plant-originated substance with cultured animal cells or meat substitute products. According to certain embodiments, the meat analog is a vegetarian food product. In other embodiments, the meat analog is a vegan food product containing only non-animal derived components and no animal-derived components. According to certain embodiments, the meat analog comprises meat replica, cultivated meat, cultured meat, clean meat, in vitro meat, synthetic meat, cell-based meat, hybrid meat comprising a plant-originated substance with cultured animal cells or meat substitute products. According to certain embodiments, the meat analog is prepared using additive manufacturing or 3D printing processes. Suitable meat analogs can be formulated, for example, without limitation, as hot dogs, burgers, ground meat, sausage links, sausage patties, kebabs, canned products, steaks, filets, roasts, breasts, thighs, wings, meatballs, meatloaf, bacon, strips, fingers, nuggets, cutlets, and cubes.

Further disclosed is a process of providing an authentic meaty flavor with improved upfront and long-lasting flavor to a meat analog, the process comprising the steps of: a) adding at least one first flavorant to a hydration step of non-animal derived protein, and b) adding at least one second flavorant to a further ingredient addition step, wherein steps a) and b) can be performed in any order.

### EXAMPLES

The following examples are given solely for the purpose of illustration and are not to be construed as limitations of the present disclosure, as many variations of the invention are possible without departing from the spirit and scope of the present disclosure.

Three chicken nugget meat analog products were prepared using non-animal derived protein. The meat analog products were prepared according to the same process except flavorant (2 wt. %) was added only during the hydration step (comparative example 1); flavorant (2 wt. %) was added only during the further ingredient addition step (comparative example 2), and flavorant was added at both the hydration step (1 wt. %) and the further ingredient addition step (1 wt. %) (inventive example 3). A chicken flavorant obtained from Givaudan Flavors Corp. (Cincinnati, Ohio) was used in the examples. The base meat analog formulation of all three examples (excluding the flavorant) is shown in Table 1 below.

TABLE 1

| Ingredients | (wt %) |
|---|---|
| Hydration Step | |
| i) water | 33.78 |
| ii) non-animal derived protein | 26.00 |
| iii) pea masker | 0.10 |
| iv) edible salt ¹ | 0.20 |
| Further Ingredient Addition Step | |
| i) edible salt | 1.00 |
| ii) pea masker² | 0.10 |
| Emulsion Step | |
| i) water | 26.12 |
| ii) non-animal fat³ | 4.70 |
| iii) methylcellose⁴ | 2.00 |
| iv) non-animal derived protein | 4.00 |

¹ No. 20 mesh was used to obtain salt chloride having an average particle size of about 850 microns.
²Pea masker obtained from Givaudan Flavors Corp.
³pure canola oil obtained from The Kroger Company.
⁴emulsifying agent.

Comparative example 1 (flavorant was added only during the hydration step) was prepared according to the following method. The hydration step was performed by adding and weighing water, non-animal derived protein, chicken flavorant, an edible salt, and pea masker in vacuum sealable bag. The bag was then vacuum sealed for 15 seconds and let to rest for 15-20 minutes until the non-animal derived protein was at least partially hydrated. The further ingredient addition step was performed by adding and weighing an edible salt and pea masker in a container. The emulsion step was performed by adding and weighing water, methylcellulose, non-animal derived protein, and pure canola oil in mini food processor. The hydration step ingredients, the further ingredient addition step ingredients, and the emulsion step ingredients were then added to a mixer and mixed for 1-2 minutes. The resulting uncooked meat analog product was then placed on to parchment paper and rolled out, subjected to blast freeze treatment, cut into nuggets, and then battered and breaded.

Comparative example 2 (flavorant was added only during the further ingredient addition step) was prepared according to the following method. The hydration step was performed by adding and weighing water, non-animal derived protein, an edible salt, and pea masker in vacuum sealable bag. The bag was then vacuum sealed for 15 seconds and let to rest for 15-20 minutes until the non-animal derived protein was at least partially hydrated. The further ingredient addition step was performed by adding and weighing chicken flavorant, an edible salt and pea masker in a container. The emulsion step was performed by adding and weighing water, methylcellulose, non-animal derived protein, and pure canola oil in mini food processor. The hydration step ingredients, the further ingredient addition step ingredients, and the emulsion step ingredients were then added to a mixer and mixed for 1-2 minutes. The resulting uncooked meat analog product was then placed on to parchment paper and rolled out, subjected to blast freeze treatment, cut into nuggets, and then battered and breaded.

Inventive example 3 (flavorant was added during both the hydration step and the further ingredient addition step) was prepared according to the following method. The hydration step was performed by adding and weighing water, non-animal derived protein, chicken flavorant, an edible salt, and pea masker in vacuum sealable bag. The bag was then vacuum sealed for 15 seconds and let to rest for 15-20 minutes until the non-animal derived protein was at least partially hydrated. The further ingredient addition step was performed by adding and weighing chicken flavorant, an edible salt and pea masker in a container. The emulsion step was performed by adding and weighing water, methylcellulose, non-animal derived protein, and pure canola oil in mini food processor. The hydration step ingredients, the further ingredient addition step ingredients, and the emulsion step ingredients were then added to a mixer and mixed for 1-2 minutes. The resulting uncooked meat analog product was then placed on to parchment paper and rolled out, subjected to blast freeze treatment, cut into nuggets, and then battered and breaded.

Sensory evaluation of the cooked chicken nugget meat analogs was performed with four trained expert panelists. The entire panel concluded that there were clear differences when flavorant was added at both the hydration step and the further ingredient addition step, as compared to adding flavorant at only the hydration step, or only at the further ingredient addition step. In particular, the panel determined that by adding flavorant in both the hydration step and the further ingredient addition step an improved upfront and long-lasting flavor can be achieved, as compared to adding flavorant at only the hydration step or only at the further ingredient addition step.

The organoleptic descriptors used by the panelists to describe comparative example 1 (flavorant was added only during the hydration step) were: “less meaty”. “less upfront meaty flavor”, “weak meaty flavor/upfront impact and lacked long-lasting flavor”, “not balanced”, and “less impact upfront”.

The organoleptic descriptors used by the panelists to describe comparative example 2 (flavorant was added only during the further ingredient addition step) were: “not as much meat flavor”, “soy off-notes”, “very weak flavor”, and “no impact”.

The organoleptic descriptors used by the panelists to describe inventive example 3 were: “increased meaty flavor level”, “savoury flavor”, and “strongest flavor impact upfront and throughout”.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

The compositional weight percentages disclosed herein are based on the total weight of the hydration step, the further ingredient addition step, the emulsion step, or the meat analog product, as the situation dictates. It will be understood to one of ordinary skill in the art that the total weight percent of the hydration step ingredients, the further ingredient addition step ingredients, the emulsion step ingredients, and the meat analog cannot exceed 100%. A person of ordinary skill in the art would understand that the amount of the components may be adjusted to include the desired amount of component without exceeding 100% by weight of the hydration step ingredients, the further ingredient addition step ingredients, the emulsion step ingredients, or the meat analog.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed processes and resulting meat analog products. Rather, these terms are merely intended to identify particular aspects of an embodiment or to emphasize alternative or additional features that may or may not be utilized in a particular embodiment.

1. A process of preparing a meat analog having an upfront and long-lasting flavor, the process comprising the steps of:
a) adding at least one first flavorant to a hydration step of non-animal derived protein, and
b) adding at least one second flavorant to a further ingredient addition step,
wherein steps a) and b) can be performed in any order.

2. The process of preparing a meat analog according to claim 1, wherein the at least one first flavorant in the hydration step is the same or different than the at least one second flavorant in the further ingredient addition step.

3. The process of preparing a meat analog according to claim 1, wherein the further ingredient addition step contains substantially no water.

4. The process of preparing a meat analog according to claim 1, wherein water is present in the hydration step in an amount of at least 50% by weight.

5. The process of preparing a meat analog according to claim 1, wherein the at least one first flavorant in the hydration step and/or the at least one second flavorant in the further ingredient addition step is selected from the group consisting of: a chicken flavor, a beef flavor, a pork flavor, a veal flavor, a duck flavor, a goose flavor, a lamb flavor, a turkey flavor, a fish flavor, a seafood flavor, and mixtures thereof.

6. The process of preparing a meat analog according to claim 1, wherein the at least one first flavorant is added in the hydration step in an amount of about 1% to about 3% by weight.

7. The process of preparing a meat analog according to claim 1, wherein the at least one second flavorant is added in the further ingredient addition step in an amount of about 40% to about 60% by weight.

8. The process of preparing a meat analog according to claim 1, wherein the at least one first flavorant in the hydration step and the at least one second flavorant in the further ingredient addition step are added in substantially the same amount based on the total weight of the meat analog.

9. The process of preparing a meat analog according to claim 1, wherein the non-animal derived protein is hydrated during the hydration step for a period of time ranging from about 15 to about 20 minutes.

10. The process of preparing a meat analog according to claim 1, wherein the non-animal derived protein comprises at least one of: beans, broccoli, mycoprotein, nuts, peas, soy, potatoes, seeds, plant leaf proteins, cereal, seitan or tofu.

11. The process of preparing a meat analog according to claim 10, wherein the beans comprise at least one of black beans, faba beans, canelli beans, kidney beans, lentil beans, lima beans, pinto beans, soy beans, white beans, mung beans; wherein the nuts comprise at least one of almonds, brazil nuts, cashews, peanuts, pecans, hazelnuts, pine nuts, walnuts; wherein the peas comprise at least one of black eyed peas, chickpeas, green peas; wherein the seeds comprise at least one of chia, flax, hemp, pumpkin, sesame, sunflower; and wherein the cereal comprises at least one of oat, wheat, barley, spelt, corn, rice.

12. The process of preparing a meat analog according to claim 10, wherein the non-animal derived protein comprises peas, soy, or mixtures thereof.

13. The process of preparing a meat analog according to claim 1, wherein the non-animal derived protein is present in an amount of about 20% to about 40% by weight, based on the total weight of the meat analog.

14. The process of preparing a meat analog according to claim 1 further comprising an emulsion step, wherein the emulsion step comprises preparing an aqueous emulsion by mixing a non-animal derived fat component with an emulsifying agent.

15. The process of preparing a meat analog according to claim 14, wherein the non-animal derived fat comprises a vegetable oil selected from the group consisting of almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

16. The process of preparing a meat analog according to claim 14, wherein the emulsion further comprises a non-animal derived protein.

17. The process of preparing a meat analog according to claim 14, wherein the hydration step, the further ingredient addition step, and the emulsion step are mixed together for a period of time ranging from about 1 to about 15 minutes.

18. A meat analog obtained by the method according to claim 1.

19. The meat analog according to claim 18, wherein the meat analog is a chicken nugget.

20. (canceled)
